(19) United States
(12) Patent Application Publication
(10) Pub. No.: US 2007/0107284 A1
(43) Pub. Date: May 17, 2007

(54) Message holder

(76) Inventor: Yvan Lamothe, Weare, NH (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(21) Appl. No.: 11/274,025

(22) Filed: Nov. 15, 2005

(51) Int. Cl. G09F 7/00

(52) U.S. Cl. 40/597; 40/604

(57) ABSTRACT

A message display system includes a support base removably mounted to a window using suction disks and a rod. The rod supports a message device (such as a banner) and is preferably secured to a rod support. The rod support is pivotably secured about the support base using a fastener such that the orientation of the rod may be easily made level. The fastener preferably includes a threaded fastener that engages a cap or the like. The rod may optionally be telescopic such that the length of the rod may be adjusted. The message device preferably includes a cavity disposed along an outer edge that is sized and shaped to accept at least a portion of the rod.

### TECHNICAL FIELD

The present invention relates to message display systems and more particularly, relates to an apparatus for releaseably securing a message to an object.

### BACKGROUND INFORMATION

In many situations, it is desirable to be able to hang pictures, banners, advertisements, messages, menu and the like to a window or in front of a window. Traditionally, tape or adhesives placed in the corners of the message being hung on the window have been used. However, tape and adhesives suffer from several drawbacks. For example, it is often difficult to ensure that the message is hung level. Additionally, replacing the message requires the message to be removed. This often results in damage to the message since the tape or adhesive must also be removed.

Accordingly, what is needed is an apparatus for hanging a message to a window or the like that is easy to level. The message should also be easily hung and removed without damaging the message. It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the following claims.

### SUMMARY

According to one embodiment, the present invention features a message display system including a display device, a rod (for example a telescopic or curved rod), a support base, and a fastener. A first surface of the support base includes at least one removable mount such as a plurality of suction cups or a hook and loop fastener. The rod is pivotably secured to a second surface of the support base by the fastener such that the rod pivots about the support base in a direction substantially parallel to the second surface of the support base. The fastener may include a threaded fastener and may engage a cap.

The display device preferably includes a cavity disposed proximate a top edge. The cavity sized and shaped to around at least a portion of the rod. According to another embodiment, at least a portion of the display device is translucent. The message display system may also include a rod base. The rod is secured to the rod base and the rod base is pivotably secured to the support base.

According to another embodiment, the present invention features a mounting device for supporting a display device. The mounting device includes a support base having at least one removable mount (such as one or more suction disks) secured to a first surface thereof. A rod (for example a telescopic or curved rod) is adapted to support the display device and is pivotably secured to a second surface of the support base such that a longitudinal axis of the rod pivots about the support base in a direction substantially parallel to the second surface of the support base. The mounting device also includes means for locking the position of the rod relative to the support base such as a threaded fastener that engages a threaded cap. The rod is optionally secured to a rod base that pivots relative to the support base about the means for locking the position of the rod.

According to a further embodiment, the present invention features a message display system. The message display system includes a display device for displaying a message and a rod sized and shaped to support the display device. A support base includes at least one removable mount (such as a suction disk or the like) secured to a first surface of the support base. The rod is secured to a rod base such that the rod extends outwardly generally parallel to a second surface of the support base. The rod base is pivotably secured to a second surface of the support base such that a longitudinal axis of the rod pivots about the support base in a direction substantially parallel to the second surface of the support base. The message display system also includes means for locking the position of the rod relative to the support base.

### BRIEF DESCRIPTION OF THE DRAWINGS

These and other features and advantages of the present invention will be better understood by reading the following detailed description, taken together with the drawings wherein:

FIG. 1 is a top plan view of one embodiment of the message display system according to the present invention;

FIG. 2 is a side perspective view of another embodiment of the message display system according to the present invention;

FIG. 3 is a side perspective view of the message display system shown in FIG. 1 taken along lines III-III;

FIG. 4 is a side perspective view of another embodiment of the message display system according to the present invention;

FIG. 5 is a side perspective view of one embodiment of the locking device according to the present invention;

FIG. 6 is a side perspective view of one embodiment of the leveling device according to the present invention;

FIG. 7 is a top plan view of yet another embodiment of the message display system according to the present invention;

FIG. 8 is an end view of one embodiment of the clip for holding the message display from the rod according to the present invention; and

FIG. 9 is an end view of another embodiment of a clip for holding the message display from the rod according to the present invention.

### DETAILED DESCRIPTION OF THE PREFERRED EMBODIMENTS

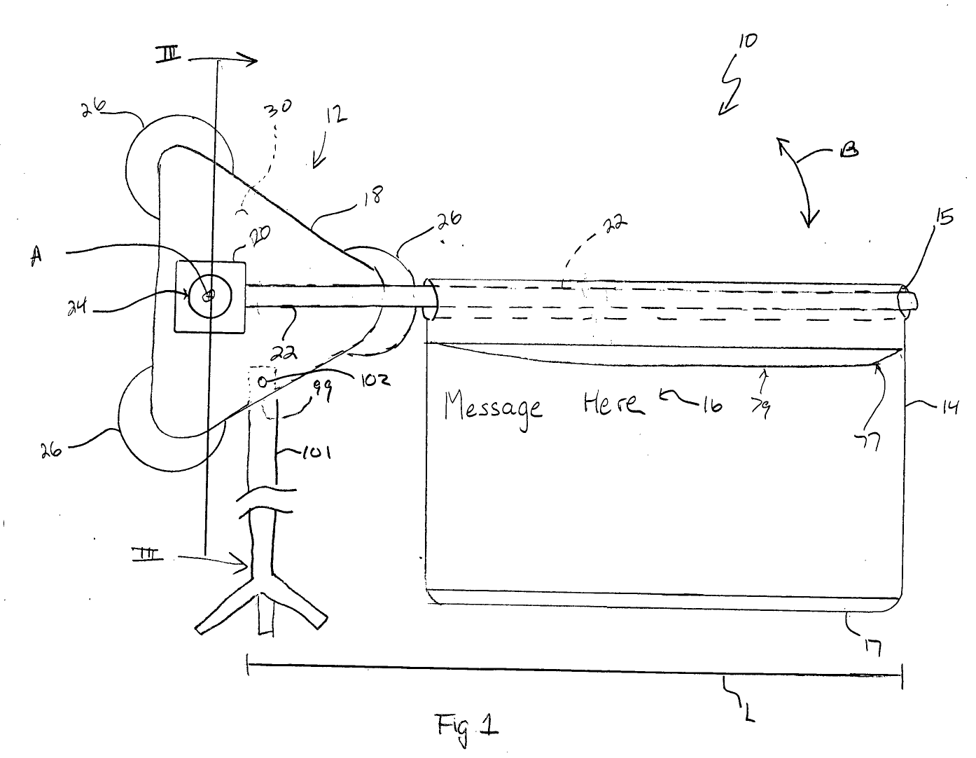

The present invention features a message display system 10, FIG. 1, including a mounting device 12 and a message display 14 for securing the message display 14 to an object such as, but not limited to, a window (automotive, commercial, or residential window). According to one embodiment, the message display 14 includes any device known to those skilled in the art for communicating a message and contains an image or indicia 16 disposed thereon. For exemplary purposes only, the indicia 16 may include a “HELP/ASSISTANCE NEEDED” message, a motivational message, self improvement message, personal goal, inspirational message, family picture, or may include an advertisement message for a particular product.

The message display 14 may include a banner, a photobanner, an advertisement, or the like and is preferably at least partially translucent. Alternatively, the message display 14 includes a sunshade/blocking device for reducing the amount of light transmitted. This embodiment is particularly useful in automotive applications and storefront applications.

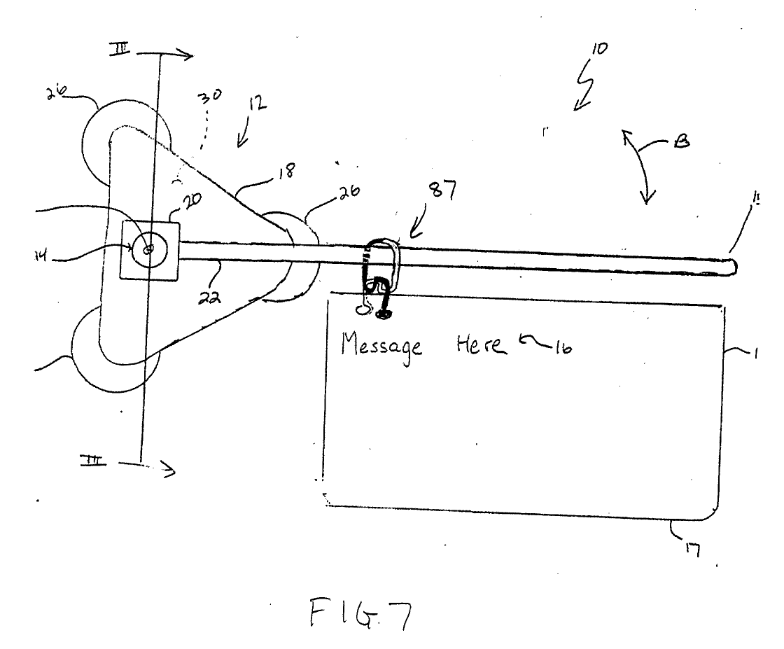

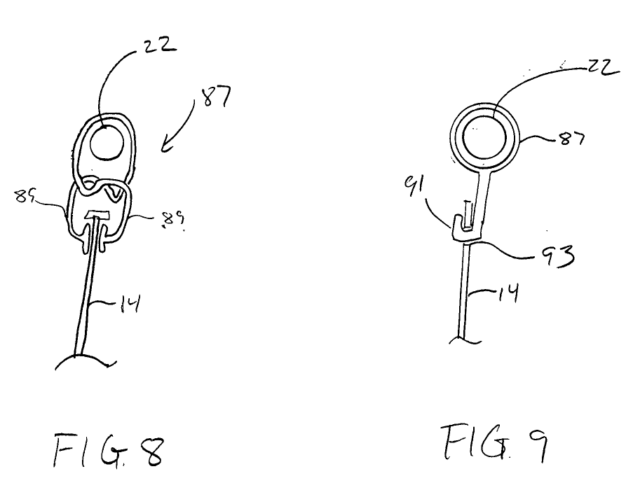

According to the preferred embodiment, the message display 14 includes a cavity 15 sized and shaped to fit around at least a portion of the rod 22 of the mounting device 12 as will be discussed in greater detail hereinbelow. Alternatively, the message display 14 may be secured to the rod 22 using one or more clips 87, FIGS. 7-9. The clips 87 may includes two or more legs 89, FIG. 8, biased towards each other that press against the front and rear of the message display 14 and hold the message display 14 in place. Alternatively, the clips 87, FIG. 9, may include one or more hooked regions 91 that fit within apertures 91 disposed in the message display 14. The present invention also features any other device known to those skilled in the art for securing the message displace 14 from the rod 22 including, but not limited to, adhesives, hook and loop fasteners, magnets, fasteners, buttons, or the like. The message display 14 optionally also includes a weight 17 preferably disposed proximate the bottom of the message display 14. The weight 17 aids in preventing air currents or the like from disturbing the message display 14.

The message display 14 may optionally include an opening 77 forming a pouch or the like. The opening 77 is sized to allow a user to insert an object to be suspended within the pouch. The message display 14 may also include fastening device 79. The fastening device 79 includes any device known to those skilled in the art for closing the opening including, but not limited to, a flap, a zip lock, adhesive, or the like.

The mounting device 12 includes a base 18 and a rod 22 pivotably secured to the base 18. The base 18 may have any shape and includes at least one releasable mount 26. In the preferred embodiment, the releasable mount 26 includes a plurality of suction cup/disk 26 disposed about a bottom surface 30 of the base 18. Alternatively, the releasable mount 26 may include one or more hook and loop fasteners, adhesives, magnets, clips, fasteners, or the like.

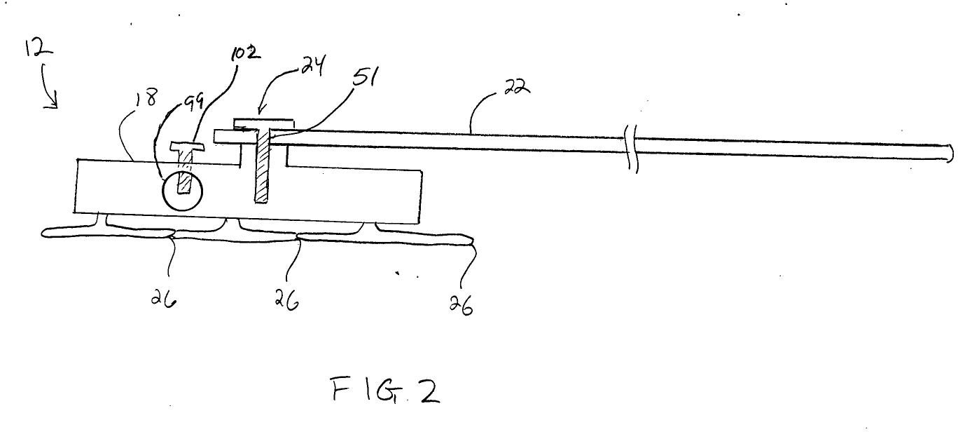

The message display system 10 may function as a stand-alone-unit and feature one or more cavities or apertures 99 (FIGS. 1 and 2) such that the message display system 10 can be secured to the frame of a stand 101. In the preferred embodiment, the cavity 99 is disposed in the base 18 of the message display system 10, though this is not a limitation of the present invention and the cavity 99 may also be disposed in the rod support 20 as will be explained hereinbelow. The cavity 99 is preferably sized to accept at least a portion of the frame of the stand 101, and is preferably secured to the frame 101 using one or more fasteners 102 such as, but not limited to, screws, bolts, magnets, or the like.

As discussed above, the rod 22 supports the message display 14. In the preferred embodiment, the rod 22 and/or the cavity 15 are sized and shaped such that at least a portion of the rod 22 fits at least partially within the cavity 15 of the message displace 14. The rod 22 is optionally telescopic such that the length L of the rod 22 may be adjusted to fit a wide variety of different width messages 14.

The rod 22 is secured to the base 18 using a locking device 24 and pivots about an axis A of the base 18 parallel to the base 18 in the direction of arrow B. In use, rod 22 is orientated in the desired position and the locking device 24 locks the position of the rod 22 relative to the base 18. As will be discussed in greater detail hereinbelow, the locking device 24 includes any means known to those skilled in the art to allow the rod 22 to pivot about the base 18 and to be secured in a desired position.

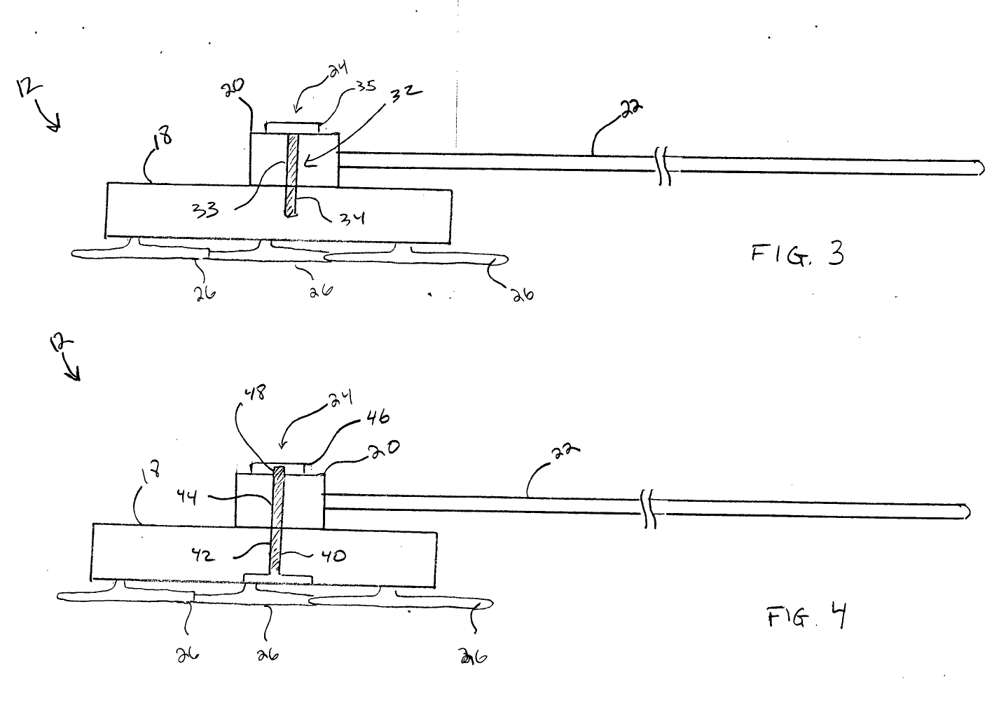

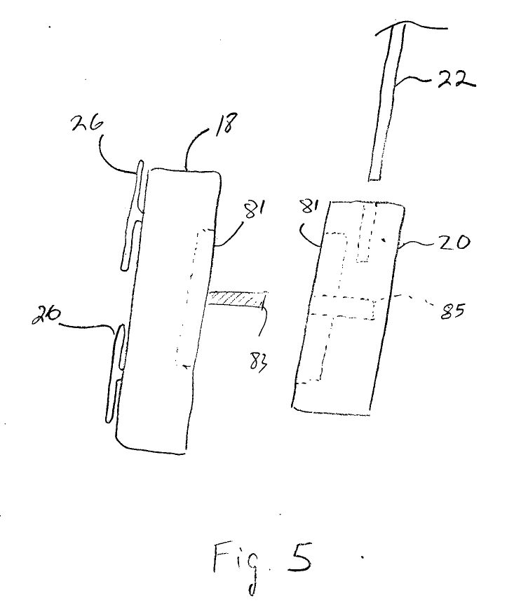

According to one embodiment, the rod 22, FIG. 2, is pivotably secured directly to the base 18 by locking device 24. The locking device 24 is preferably disposed at least partially within an aperture 51 of the rod 22 and generates a force against rotation between the base 18 and the rod 22. According to another embodiment, the rod 22, FIGS. 3 and 4, is secured/supported directly to a rod support 20. The rod 22 may be removable from the rod support 20 such that various lengths of rods 22 may be used to accommodate a wide variety of message devices 14. In any event, the rod support 22 is secured to the base 18 by the locking device 24 and pivots with respect to the base 18.

According to one embodiment, the locking device 24, FIG. 3, may include a fastener 32 such as a bolt or the like disposed through an aperture 33 in the rod support 20 (or rod 22 in the embodiment wherein the rod support 20 is not used) and which threadably engages a threaded region 34 of the base 18. The fastener 32 preferably includes a head or cap 35 sized and shaped to facilitate the threading of the fastener 32 into the threaded region 34 of the base 18.

Alternatively, the locking device 24, FIG. 4, includes a fastener 40 such as a bolt/pivot screw or the like disposed through a first aperture 42 in the base 18 and a second aperture 44 in the rod support 20 (or rod 22 in the embodiment wherein the rod support 20 is not used). The fastener 40 threadably engages a cap 46 having a threaded region 48.

According to a further embodiment, the locking device 24, FIG. 5, includes at least one magnet 81. In the preferred embodiment, both the base 18 and the rod support 20 include a magnet 81 arranged with poles opposite each other such that the magnets 81 attract each other. Alternatively, either the base 18 or the rod support 20 may include a magnet 81 and opposite side may include a magnetically active material.

The base 18 also preferably includes a post 83 or the like extending generally outwardly. The rod support 20 includes an aperture 85 sized and shaped to accept the post 83. The combination of the post 83 and the aperture 85 increases the load capacity of the message display system 10.

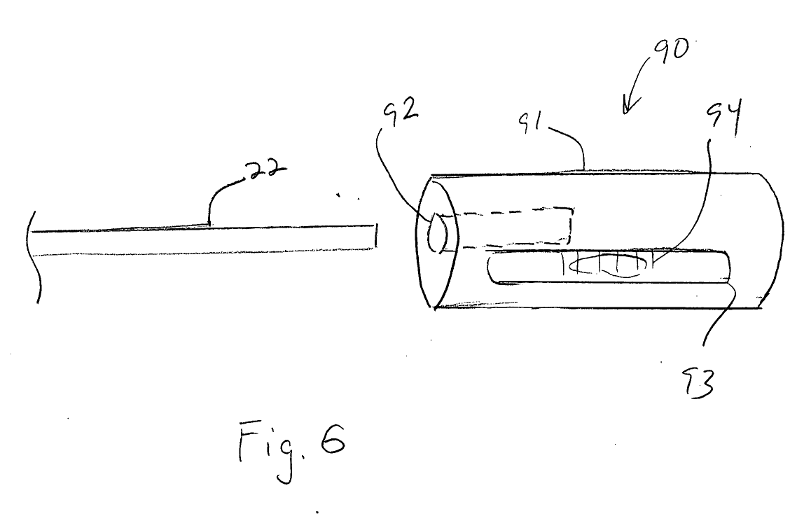

The present invention optionally includes a leveling device 90, FIG. 6. In the preferred embodiment, the leveling device 90 includes a body 91 having at least one aperture 92. The aperture 92 is sized and shaped to fit over at least one a portion of the end of the rod 22. The body also includes a leveling window 93, preferably having a plurality of leveling indicia 94. In use, the user places the leveling device 90 over the end of the rod 22 while the locking device 24 is loose and secures the message display system 10 to the support surface. Using the leveling device 90, the user adjusts the rod 22 to the desired setting and tightens the locking device 24.

Accordingly, the present invention allows a message device to be easily hung and leveled. Additionally, the present invention allows the message device to be removed without damaging the message device or the receiving surface (for example, but not limited to, a window, wall, or the like). As mentioned above, the present invention is not intended to be limited to a system or method which must satisfy one or more of any stated or implied object or feature of the invention and should not be limited to the preferred, exemplary, or primary embodiment(s) described herein. The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as is suited to the particular use contemplated. All such modifications and variations are within the scope of the invention as determined by the claims when interpreted in accordance with breadth to which they are fairly, legally and equitably entitled.

The invention claimed is:

1. A message display system comprising:
a display device;
a rod;
a support base including at least one removable mount secured to a first surface; and
a fastener pivotably securing said rod to a second surface of said support base such that said rod pivots about said support base in a direction substantially parallel to said second surface of said support base.

2. The message display system as claimed in claim 1 wherein said display device includes a cavity disposed proximate a top edge, said cavity sized and shaped to around at least a portion of said rod.

3. The message display system as claimed in claim 2 wherein at least a portion of said display device is translucent.

4. The message display system as claimed in claim 1 wherein at least one mounting device includes a plurality of suction cups.

5. The message display system as claimed in claim 1 wherein at least one mounting device includes a hook and loop fastener.

6. The message display system as claimed in claim 1 further including a rod base, wherein said rod is secured to said rod base and wherein said rod base is pivotably secured to said support base.

7. The message display system as claimed in claim 1 wherein said rod includes a telescopic rod.

8. The message display system as claimed in claim 1 wherein said fastener includes a threaded fastener.

9. The message display system as claimed in claim 8 wherein said threaded fastener engages a threaded region in said support base.

10. The message display system as claimed in claim 6 wherein said fastener includes a threaded fastener and wherein said threaded fastener engages a threaded region in said rod base.

11. A mounting device for supporting a display device comprising:
a support base including at least one removable mount secured to a first surface;
a rod adapted to support said display device, said rod pivotably secured to a second surface of said support base such that a longitudinal axis of said rod pivots about said support base in a direction substantially parallel to said second surface of said support base; and
means for locking the position of said rod relative to said support base.

12. The mounting device as claimed in claim 11 further including a rod base, wherein said rod is secured to said rod base and wherein said rod base pivots relative to support base.

13. The mounting device as claimed in claim 11 wherein said at least one removable mount includes at least one suction disk.

14. The mounting device as claimed in claim 11 wherein said rod includes a telescopic rod.

15. The mounting device as claimed in claim 11 wherein said means for locking includes a threaded fastener.

16. The mounting device as claimed in claim 15 wherein said means for locking further includes a cap, wherein said threaded fastener is secured to support base and extends outwardly beyond and generally perpendicular to said second surface of said support base, wherein said cap engages said threaded fastener.

17. A message display system including:
a display device for displaying a message;
a rod, said rod sized and shaped to support said display device;
a support base including at least one removable mount secured to a first surface;
a rod base including a rod extending outwardly generally parallel to a second surface of said support base, said rod base pivotably secured to a second surface of said support base such that a longitudinal axis of said rod pivots about said support base in a direction substantially parallel to said second surface of said support base; and
means for locking the position of said rod relative to said support base.

18. The display system as claimed in claim 17 wherein said at least one removable mount includes at least one suction disk.

19. The display system as claimed in claim 17 wherein said rod includes a telescopic rod.

20. The display system as claimed in claim 17 wherein said display device further includes a cavity sized and shaped to accept at least a portion of said rod.
